(19) United States
(12) Patent Application Publication
(10) Pub. No.: US 2025/0079745 A1
(43) Pub. Date: Mar. 6, 2025

(54) CONNECTOR

(71) Applicant: HIROSE ELECTRIC CO., LTD., Kanagawa (JP)

(72) Inventor: Ryota OSAKI, Kanagawa (JP)

(21) Appl. No.: 18/810,058

(22) Filed: Aug. 20, 2024

(30) Foreign Application Priority Data
Sep. 6, 2023 (JP) 2023-144133

(51) Int. Cl. H01R 13/50; H01R 13/42

(52) U.S. Cl. CPC H01R 13/50; H01R 13/42

(57) ABSTRACT

Provided is a connector which includes a terminal; and a housing, in which the connector includes a terminal row in which a plurality of the terminals is arranged in a longitudinal direction of the connector, and a plurality of the terminal rows is provided so as to face each other in a lateral direction of the connector; the housing has a fitting recessed portion in which a partner connector is to be fitted and a cutout portion; the fitting recessed portion is recessed between the terminal rows on one end side of the housing in a fitting direction perpendicular to the longitudinal direction and the lateral direction; and the cutout portion is recessed between the terminal rows at least on the other end side of the housing in the fitting direction.

### CROSS-REFERENCE TO RELATED APPLICATION

This application claims priority from Japanese Patent Application No. 2023-144133 filed with the Japan Patent Office on Sep. 6, 2023, the entire content of which is hereby incorporated by reference.

### BACKGROUND

### 1. Technical Field

The present disclosure relates to a connector.

### 2. Related Art

A partner connector is fitted in a connector, and a terminal of the connector and a partner terminal of the partner connector contact each other to connect the connector and the partner connector to each other. The connector has a plurality of terminals corresponding to a plurality of partner terminals of the partner connector. The connector is insert-molded with, e.g., a resin housing in a state of the plurality of terminals being arranged in two rows according to the partner terminals arranged at least in two rows. In a case where the partner connector has a fitting raised portion between the two rows of the arranged partner terminals, the connector has a fitting recessed portion, in which the fitting raised portion is to be fitted, between the two rows of the arranged terminals. The fitting recessed portion has a depth corresponding to the height of the fitting raised portion.

For example, in JP-A-2000-164283, an electric connector includes a housing made of an insulating material and having a recess formed by the inner surfaces of opposing side walls and a plurality of terminals attached to the housing. The insulating housing is made of a plastic material. The terminals are at least partially insert-molded with the housing.

### SUMMARY

A connector according to an embodiment of the present disclosure is a connector which includes a terminal; and a housing, in which the connector includes a terminal row in which a plurality of the terminals is arranged in a longitudinal direction of the connector, and a plurality of the terminal rows is provided so as to face each other in a lateral direction of the connector; the housing has a fitting recessed portion in which a partner connector is to be fitted and a cutout portion; the fitting recessed portion is recessed between the terminal rows on one end side of the housing in a fitting direction perpendicular to the longitudinal direction and the lateral direction; and the cutout portion is recessed between the terminal rows at least on the other end side of the housing in the fitting direction.

### BRIEF DESCRIPTION OF THE DRAWINGS

FIG. 1 is a perspective view showing a connector of an embodiment of the present disclosure;

FIG. 2 is a perspective view showing a partner connector fittable in the connector of the embodiment of the present disclosure;

FIG. 3 is a sectional view showing a state of the connector of the embodiment of the present disclosure and the partner connector 2 being separated from each other;

FIG. 4 is an exploded view showing a state of a plurality of terminals and a housing of the connector of the embodiment of the present disclosure being separated from each other;

FIG. 5 is a top view showing the connector of the embodiment of the present disclosure;

FIG. 6 is a side view showing the connector of the embodiment of the present disclosure;

FIG. 7 is a sectional view of the connector viewed from a direction of a VII-VII line in FIG. 5;

FIG. 8 is a sectional view of the connector viewed from a direction of a VIII-VIII line in FIG. 6;

FIG. 9 is a sectional perspective view of the connector viewed from the direction of the VII-VII line in FIG. 5;

FIG. 10 is a sectional perspective view of the connector viewed from the direction of the VIII-VIII line in FIG. 6;

FIG. 11 is a sectional perspective view of the connector viewed from a direction of an III-III line in FIG. 6;

FIG. 12 is a side view showing the terminal of the connector of the embodiment of the present disclosure; and

FIG. 13 is a perspective view showing the terminal of the connector of the embodiment of the present disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the connector formed by insert-molding the plurality of terminals with the housing as described above, when the inside of the housing is densely filled with resin, only the resin contracts inward after insert molding due to a difference in the coefficient of expansion between the housing and the terminal. Due to such resin contraction, the terminals are deformed so as to be pulled inward, and for example, the two opposing terminal rows are deformed so as to be pulled inward due to contraction of resin charged between the two terminal rows. When the terminals are deformed as described above, the heights of the tip ends (mount portions) of the terminals which are to contact the partner terminals are not uniform, which leads to a probability that the terminals cannot be mounted. When the tip end (mount portion) of the terminal is deformed so as to expand outward due to inward deformation of an intermediate portion of the terminal, there is a probability that contact failure between the terminal and the partner terminal and fitting failure between the connector and the partner connector are caused.

The present disclosure has been made, for example, in view of the above-described problems, and one object of the present disclosure is to provide a connector configured so that influence of thermal contraction of resin of a housing insert-molded with terminals can be suppressed.

The connector of the present disclosure is a connector which includes a terminal; and a housing, in which the connector includes a terminal row in which a plurality of the terminals is arranged in a longitudinal direction of the connector, and a plurality of the terminal rows is provided so as to face each other in a lateral direction of the connector; the housing has a fitting recessed portion in which a partner connector is to be fitted and a cutout portion; the fitting recessed portion is recessed between the terminal rows on one end side of the housing in a fitting direction perpendicular to the longitudinal direction and the lateral direction; and the cutout portion is recessed between the terminal rows at least on the other end side of the housing in the fitting direction.

The housing may include the number of the cutout portions according to the number of the plurality of the terminals arranged in the longitudinal direction, and the cutout portion may be provided over an area where a predetermined number of the plurality of the terminals is arranged in the longitudinal direction.

The housing may have, on the one end side in the fitting direction, the cutout portion recessed toward the other end side in the fitting direction from a bottom surface of the fitting recessed portion.

The cutout portion may be formed to expand in diameter as extending outward of the housing.

The terminal may be formed in a shape long in the fitting direction, the housing may be formed to have a height corresponding to a length of the terminal in the fitting direction, and the cutout portion may be formed to a depth of 50 to 80% of the height of the housing in the fitting direction.

According to the present disclosure, the influence of the thermal contraction of the resin of the housing insert-molded with the terminals can be suppressed.

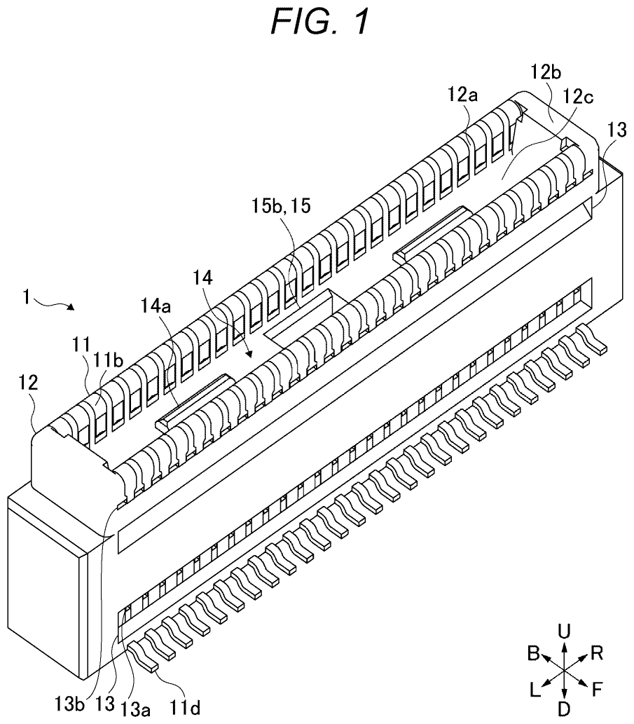

A connector 1 of an embodiment of the present disclosure will be described using the drawings. Note that in the embodiment of the present disclosure, the direction of up (U), down (D), front (F), back (B), left (L), or right (R) will be described according to an arrow shown in FIGS. 1 to 13 for the sake of convenience in description.

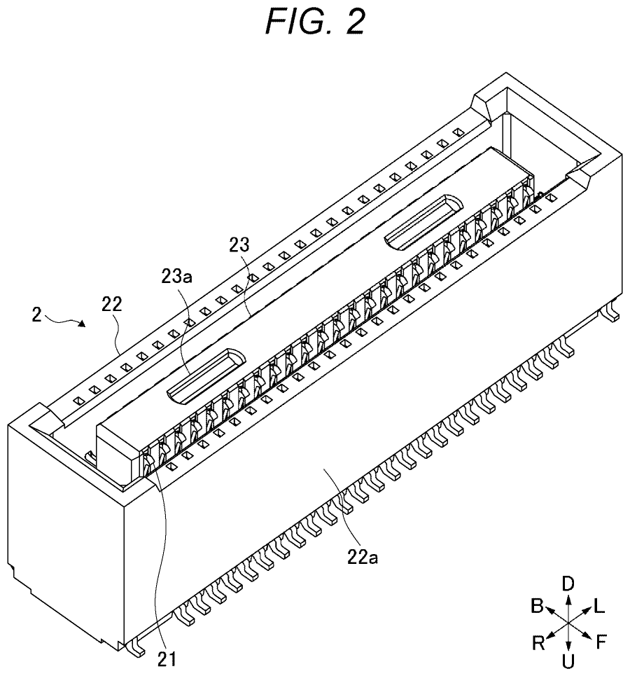

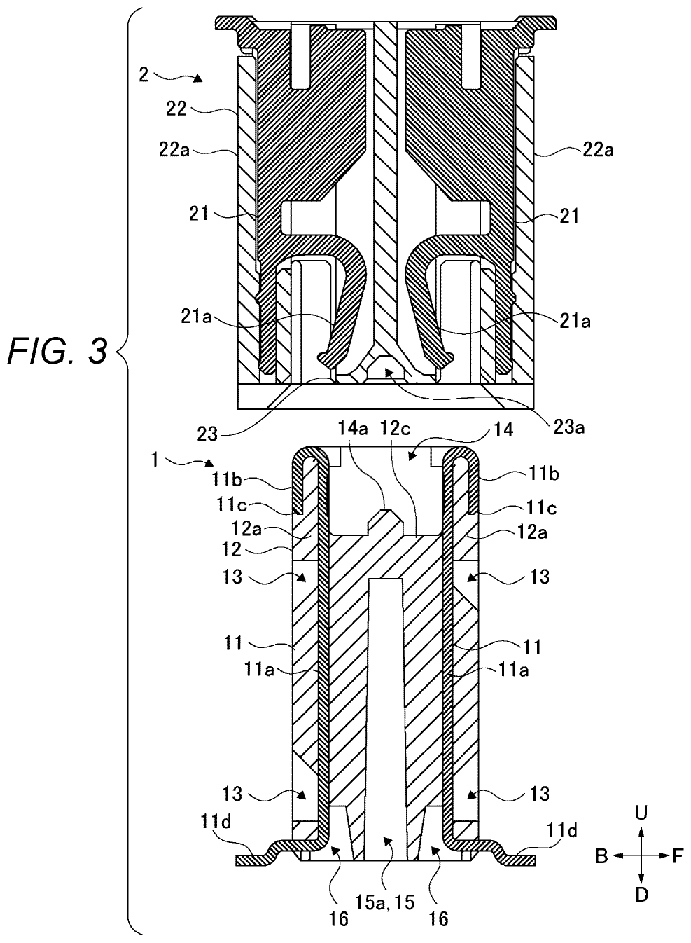

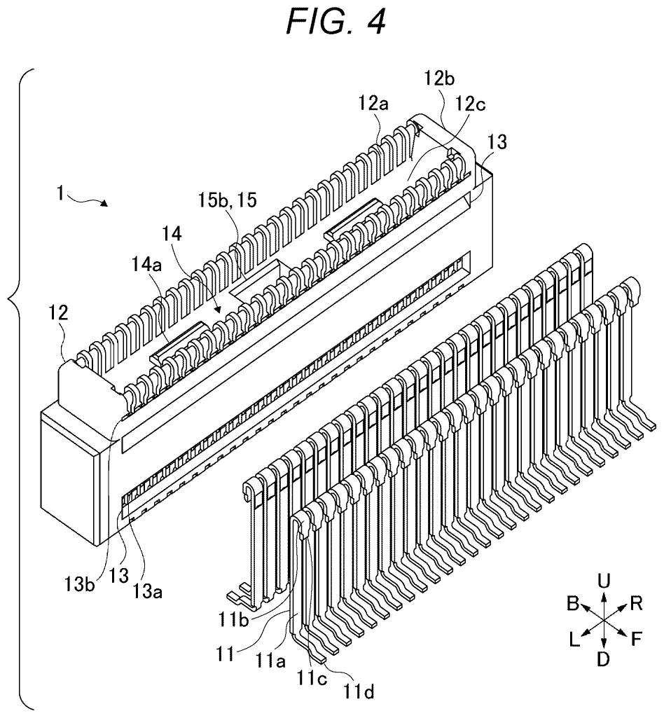

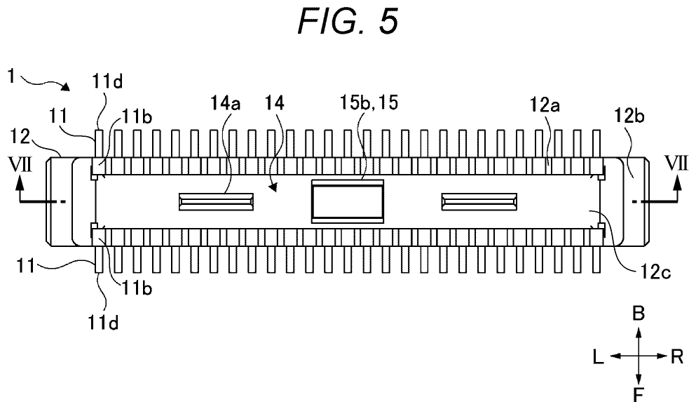

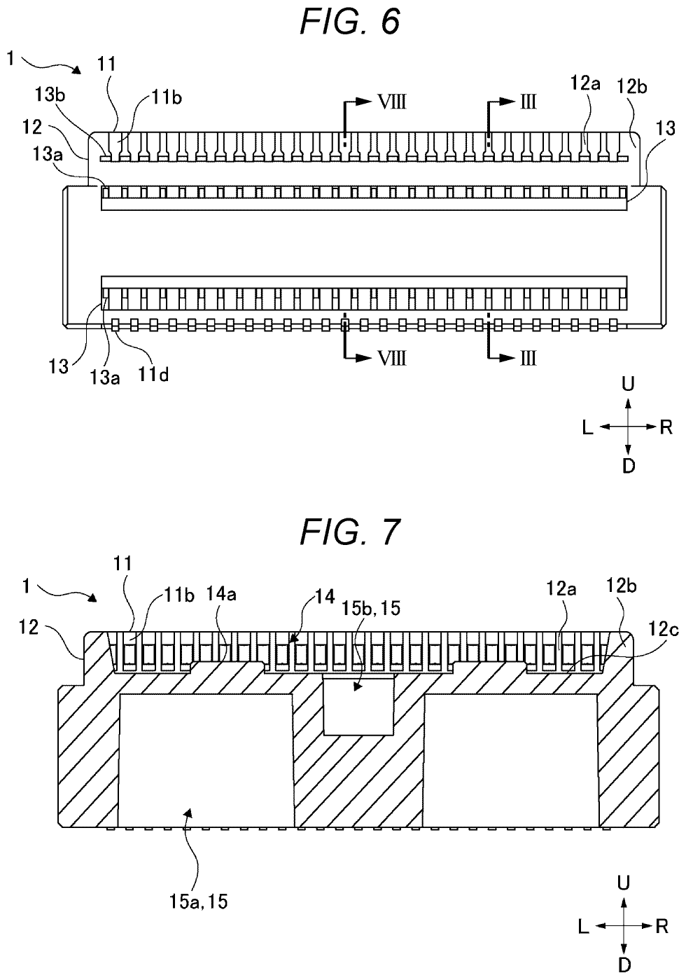

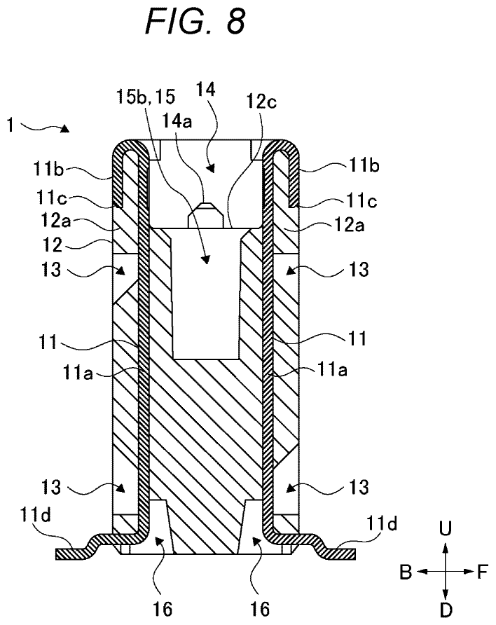

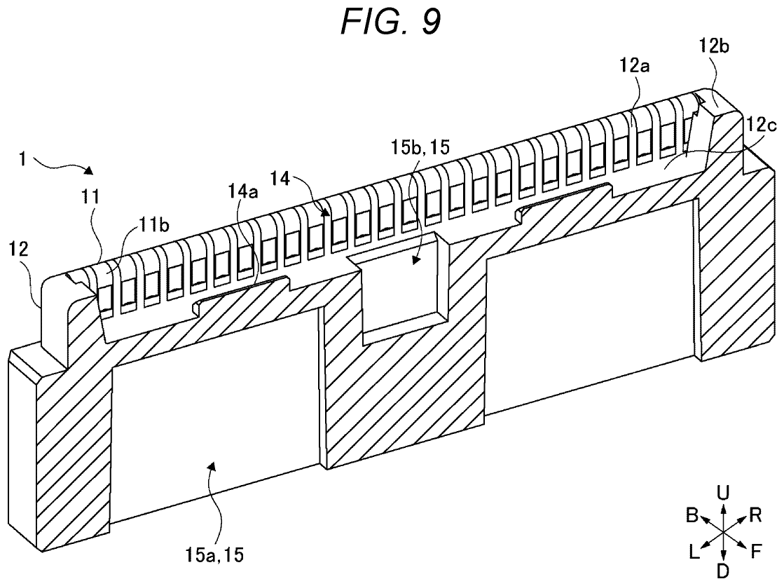

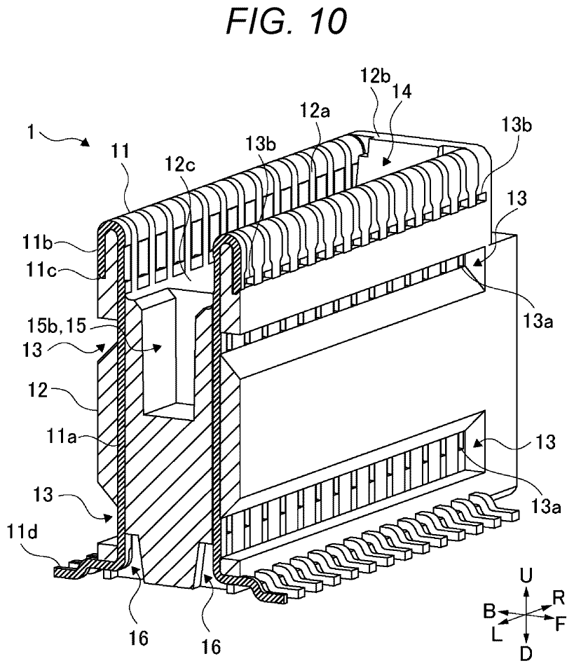

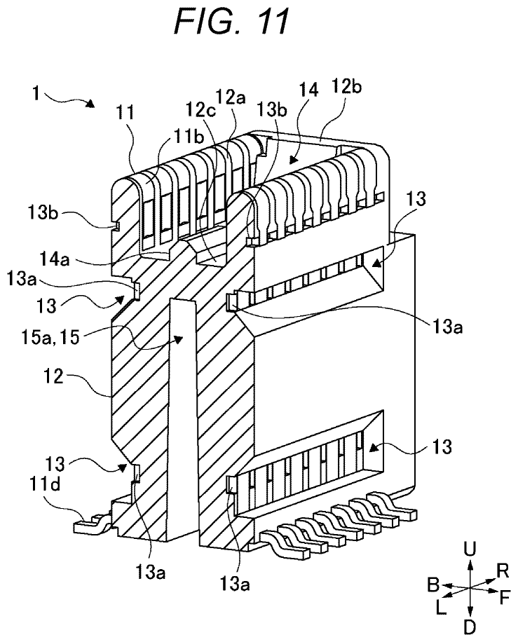

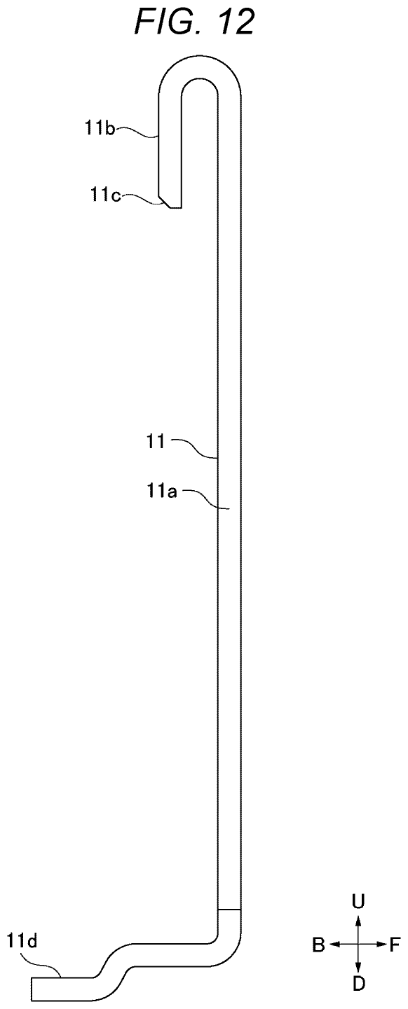

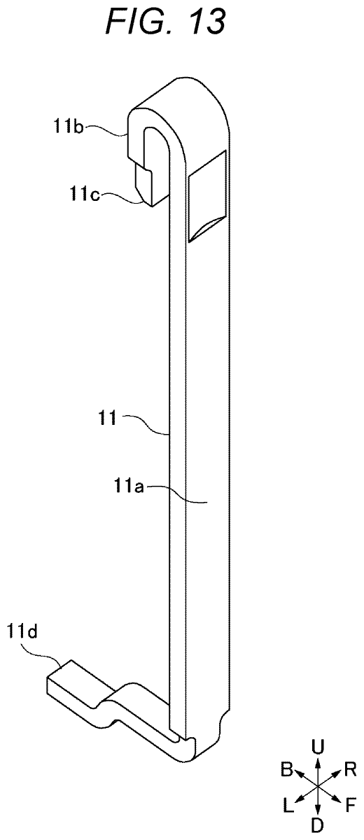

FIG. 1 shows the connector 1 according to the embodiment of the present disclosure. FIG. 1 is a perspective view of the connector 1, and FIG. 2 is a perspective view of a partner connector 2 fittable in the connector 1. FIG. 3 is a sectional view showing a state of the connector 1 and the partner connector 2 being separated from each other, and the sectional view of the connector 1 is an III-III sectional view of the connector 1 of FIG. 6. FIG. 4 is an exploded view showing a state of a plurality of terminals 11 and a housing 12 of the connector 1 being separated from each other. FIG. 5 is a top view of the connector 1, and FIG. 6 is a side view of the connector 1. FIG. 7 is a VII-VII sectional view of the connector 1 of FIG. 5, and FIG. 8 is a VIII-VIII sectional view of the connector 1 of FIG. 6. FIG. 9 is a VII-VII sectional perspective view of the FIG. 5, FIG. 10 is a VIII-VIII sectional perspective view of FIG. 6, and FIG. 11 is an III-III sectional perspective view of FIG. 6. FIG. 12 is a side view of the terminal 11, and FIG. 13 is a perspective view of the terminal 11.

The connector 1 and the partner connector 2 are applied, for example, to connection between one board and another board or connection between a board and a flat conductor such as an FPC. Specifically, the connector 1 is mounted on a predetermined board.

The partner connector 2 has a plurality of partner terminals 21, and the connector 1 has the plurality of terminals 11 corresponding to the plurality of partner terminals 21. When the partner connector 2 is fitted in the connector 1, the plurality of partner terminals 21 and the plurality of terminals 11 electrically contact each other, and accordingly, the partner connector 2 is connected to the connector 1. In FIG. 3, a direction of fitting the partner connector 2 and the connector 1 in each other is the up-down direction, and specifically, the partner connector 2 is fitted in the connector 1 from above.

As shown in FIGS. 2 and 3, the partner connector 2 includes the plurality of partner terminals 21 arranged in a partner housing 22. For example, the plurality of partner terminals 21 has a plurality of partner terminal rows (for example, two rows) in each of which a predetermined number of partner terminals 21 is arranged in a predetermined arrangement direction. In FIG. 2, the arrangement direction of the plurality of partner terminals 21 is the left-right direction, and the fitting direction (up-down direction) of the partner connector 2 and the connector 1 is perpendicular to the arrangement direction (left-right direction) of the plurality of partner terminals 21. Moreover, in FIG. 2, the partner terminals 21 are arranged in two rows which are a front row (row on the F-side in FIG. 2) and a back row (row on the B-side in FIG. 2).

The partner housing 22 has wall portions 22a on the front side (F-side) of the front row of the partner terminals 21 and the back side (B-side) of the back row of the partner terminals 21. A fitting raised portion 23 for fitting the partner connector 2 in the connector 1 is provided in a lower portion of the partner housing 22. The fitting raised portion 23 is formed between the front and back wall portions 22a and between the terminal rows adjacent to each other, i.e., between the front row of the partner terminals 21 and the back row of the partner terminals 21, so as to protrude downward. Note that an engagement recessed portion 23a is recessed in the tip end surface (lower surface) of the fitting raised portion 23. The engagement recessed portion 23a engages with an engagement raised portion 14a (see FIG. 1) of the connector 1, thereby further positioning the partner connector 2 relative to the connector 1.

As shown in FIGS. 1 and 3 to 11, the connector 1 has the housing 12 insert-molded with the plurality of arranged terminals 11. In FIGS. 1 and 3 to 11, the arrangement direction of the plurality of terminals 11 is the left-right direction. In a state of the plurality of arranged terminals 11 being held by four-direction (front, back, upper, and lower) dies, a space surrounded by the dies is filled with resin, and in this manner, the housing 12 is insert-molded with the plurality of terminals 11. The housing 12 is formed in a substantially rectangular parallelepiped shape whose longitudinal direction is the arrangement direction of the terminals 11.

For example, the plurality of terminals 11 of the connector 1 has, corresponding to the rows of the plurality of partner terminals 21 of the partner connector 2, a plurality of terminal rows (e.g., two rows) in each of which a predetermined number of terminals 11 is arranged in a predetermined arrangement direction.

The plurality of terminals 11 has the same shape. The front row of the terminals 11 and the back row of the terminals 11 are symmetrically arranged. Each terminal 11 is made of a conductive material such as metal, and as shown in FIGS. 1, 3, 4, 8, 10, 12, and 13, is a long member extending in the up-down direction.

Each terminal 11 has a base portion 11a, a tip end portion 11b, an outer corner portion 11c, and a mount portion 11d. The base portion 11a extends linearly, and is embedded in the housing 12 by insert molding. Each terminal 11 is insert-molded with the housing 12 in a state of the base portion 11a extending in the up-down direction. The tip end portion 11b (upper end portion of the terminal 11) is a contact portion which is to contact the partner terminal 21 of the partner connector 2. The tip end portion 11b is formed continuously from the base portion 11a on one end side of each terminal 11, and is curved outward (front side or back side) in an inverted U-shape. The outer surface of the tip end portion 11b is exposed from the housing 12. The outer corner portion 11c is provided at the tip end (upper end) of each terminal 11, is cut out in a tapered shape, and engages with the housing 12. The outer corner portion 11c suppresses outward projection of the tip end (upper end) of each terminal 11 from the housing 12. The mount portion 11d is a base end portion (lower end portion of the terminal 11) formed continuously from the base portion 11a on the other end side of each terminal 11. The mount portion 11d is bent outward (front side or back side), and protrudes from the housing 12.

Note that each partner terminal 21 of the partner connector 2 has a tip end portion 21a (lower end portion of the partner terminal 21). The tip end portion 21a is branched into two in the front-back direction so as to contact the tip end portion 11b of each terminal 11 of the connector 1 from the front side or the back side.

The front and back dies (not shown) for insert-molding the housing 12 have holding raised portions (not shown) for holding the front row of the terminals 11 and the back row of the terminals 11. Holding recessed portions 13 are formed in the front and back surfaces of the housing 12 by the holding raised portions of the dies. The holding recessed portion 13 is formed over a region where the plurality of terminals 11 is arranged in the arrangement direction (left-right direction) of the terminals 11, and is formed to expand in diameter as extending outward (front side or back side) in a direction of removing the die.

Note that part of the terminals 11 is exposed in the holding recessed portions 13 because the terminals 11 are held with the front and back dies. Further, the front and back dies hold the side surfaces of the terminals 11 (base portions 11a) upon insert molding so that the position accuracy of the plurality of terminals 11 can be improved. In this case, the portions of the dies holding the side surfaces of the base portions 11a are removed, and accordingly, first additional recessed portions 13a are also formed on the sides of each terminal 11 (base portion 11a) in the holding recessed portions 13. In addition, the front and back dies hold the side surfaces of the tip end portion 11b of each terminal 11 so that the position accuracy of the tip end portions 11b which are free end portions easily shakable upon insert molding can be improved. In this case, the portions of the dies holding the side surfaces of the tip end portions 11b are removed, and accordingly, second additional recessed portions 13b are also formed on the sides of the tip end portion 11b of each terminal 11 in the holding recessed portions 13.

In an upper portion of the housing 12, a fitting recessed portion 14 in which the fitting raised portion 23 of the partner connector 2 is to be fitted is recessed between the terminal rows adjacent to each other, i.e., between the front row of the terminals 11 and the back row of the terminals 11. The fitting recessed portion 14 is formed by the upper die. The fitting recessed portion 14 has a depth corresponding to the height of the fitting raised portion 23, and is formed to expand left and right in diameter as extending outward (upper side) in a direction of removing the die.

Moreover, in a lower portion of the housing 12, a lower recessed portion 16 is recessed in the vicinity of the mount portions 11d of the terminals 11. The lower recessed portion 16 is formed by the lower die holding the lower side of the terminals 11.

For example, the housing 12 has a pair of side walls 12a extending in the arrangement direction (left-right direction) of the terminals 11 and a pair of end walls 12b coupling end portions of the pair of side walls 12a in the left-right direction to each other, and at the upper portion of the housing 12, has a bottom portion 12c connecting the pair of side walls 12a and the pair of end walls 12b in the horizontal direction. The fitting recessed portion 14 is formed in a region defined by the pair of side walls 12a, the pair of end walls 12b, and the bottom portion 12c. Each side wall 12a holds the tip end portions 11b of the predetermined number of terminals 11 arranged in one terminal row, and the surface of the side wall 12a and the surfaces of the tip end portions 11b are flush with each other.

The tip end portions 11b (upper end portions) of the terminals 11 insert-molded with the housing 12 are exposed from the housing 12 at the front and back inner wall surfaces of the fitting recessed portion 14, i.e., the surfaces of the pair of side walls 12a. Note that the engagement raised portion 14a to be engaged with the engagement recessed portion 23a of the partner connector 2 is formed so as to protrude upward from the bottom surface of the fitting recessed portion 14, i.e., the bottom portion 12c. An outer corner portion of the tip end (upper end) of the engagement raised portion 14a is cut out in a tapered shape.

Further, the housing 12 has a cutout portion 15. The cutout portion 15 is recessed in the fitting direction (up-down direction, longitudinal direction of the terminal 11) of the partner connector 2 and the connector 1 between the terminal rows adjacent to each other, i.e., between the front row of the terminals 11 and the back row of the terminals 11. The cutout portion 15 is provided separately from the fitting recessed portion 14 corresponding to the fitting raised portion 23 of the partner connector 2 and the holding recessed portions 13 used for holding the plurality of terminals 11 with the dies.

For example, the cutout portion 15 includes a lower cutout portion 15a and an upper cutout portion 15b. The lower cutout portion 15a is recessed upward from the lower surface in the lower portion of the housing 12. In other words, the lower cutout portion 15a is recessed so as to open to the lower side (lower surface side) of the housing 12. The upper cutout portion 15b is further recessed downward from the bottom surface of the fitting recessed portion 14 in the upper portion of the housing 12.

The cutout portion 15 is formed as a substantially rectangular parallelepiped space. The cutout portion 15 has a width over a predetermined number of terminals 11 in the arrangement direction of the terminals 11. The cutout portion 15 is preferably recessed toward the position of the housing 12 corresponding to an intermediate portion of the terminal 11 in the longitudinal direction thereof. For example, the cutout portion 15 is preferably formed to a depth of 50 to 80% of the height of the housing 12 or the length of the terminal 11 in the up-down direction (fitting direction), more preferably a depth of 50 to 70%.

The cutout portion 15 is formed to expand forward, backward, leftward, and rightward in diameter as extending outward. Specifically, the lower cutout portion 15a is formed to expand in diameter as extending downward, and the upper cutout portion 15b is formed to expand in diameter as extending upward.

Specifically, the housing 12 has, in the upper portion (side facing the partner connector 2, which is one end side in the fitting direction of the partner connector 2 and the connector 1), the fitting recessed portion 14 corresponding to the fitting raised portion 23 of the partner connector 2. Thus, the housing 12 has the lower cutout portion 15a at least in the lower portion (other end side in the fitting direction, which is opposite to the fitting recessed portion 14). The housing 12 may have the upper cutout portion 15b in addition to the lower cutout portion 15a. Note that the upper cutout portion 15b is provided at a position different from that of the engagement raised portion 14a in the arrangement direction of the terminals 11 in the bottom surface of the fitting recessed portion 14.

The housing 12 has the number of cutout portions 15 according to the number of terminals 11 arranged in each row. For example, in a case where the number of terminals is relatively great, a plurality of (e.g., two) lower cutout portions 15a is provided in the lower portion of the housing 12 at predetermined intervals in the arrangement direction of the terminals 11. In a case where the number of terminals is greater, the upper cutout portion 15b is preferably provided in the upper portion of the housing 12 in addition to the lower cutout portions 15a. In this case, the upper cutout portion 15b is provided at a position different from those of the lower cutout portions 15a in the arrangement direction of the terminals 11. Note that in a case where the number of terminals is relatively small, only one lower cutout portion 15a may be provided in the lower portion of the housing 12.

As described above, according to the present embodiment, the connector 1 has the plurality of terminals 11 and the housing 12 insert-molded with the plurality of terminals 11. The plurality of terminals 11 has the plurality of terminal rows in each of which the predetermined number of terminals 11 is arranged in the predetermined arrangement direction. The housing 12 has the fitting recessed portion 14 which is recessed between the terminal rows adjacent to each other on the one end side in the fitting direction perpendicular to the arrangement direction and in which the partner connector 2 is to be fitted, and the cutout portion 15 (lower cutout portion 15a) recessed between the terminal rows adjacent to each other at least on the other end side (lower side) in the fitting direction.

The fitting recessed portion 14 is recessed so as to open to the upper side (upper surface side, specifically bottom portion 12c side of the housing 12) of the housing 12, and the lower cutout portion 15a is recessed so as to open to the lower side (lower surface side) of the housing 12.

The arrangement direction (left-right direction) of the terminals 11 is the longitudinal directions of the connector 1 and the housing 12. The plurality of terminal rows faces each other in the lateral directions (front-back direction) of the connector 1 and the housing 12 with a gap therebetween. The fitting recessed portion 14 and the lower cutout portion 15a are provided between the plurality of terminal rows.

With this configuration, the amount of resin charged on the center side of the housing 12 by insert molding can be reduced in the connector 1. Thus, the amount of inward contraction of the resin of the housing 12 after insert molding can be reduced. Consequently, deformation of the terminals 11 into the housing 12 due to resin contraction can be suppressed. As a result, the plurality of terminals 11 can have a uniform height, and contact failure between the terminal 11 and the partner terminal 21 and fitting failure between the connector 1 and the partner connector 2 can be suppressed. According to the connector 1 of the present disclosure, the influence of the thermal contraction of the resin of the housing 12 insert-molded with the terminals 11 can be suppressed.

Further, according to the connector 1 of the present embodiment, the housing 12 has the number of cutout portions 15 according to the number of terminals 11, and the cutout portion 15 is provided over the predetermined number of terminals 11 in the arrangement direction. The number of cutout portions 15 preferably increases as the number of arranged terminals 11 increases. Moreover, the cutout portion 15 is preferably provided over an area where the plurality of terminals is arranged in the longitudinal direction of the connector 1. A proper number of cutout portions 15 is provided according to the number of terminals 11 so that the influence of the thermal contraction of the resin of the housing 12 can be suppressed.

In addition, according to the connector 1 of the present embodiment, the housing 12 has, on the one end side in the fitting direction, the cutout portion 15 (upper cutout portion 15b) further recessed from the fitting recessed portion 14.

Specifically, as the upper cutout portion 15b, the housing 12 may have, on the one end side (upper side) in the fitting direction, the cutout portion 15 recessed toward the other end side (lower side) in the fitting direction from the bottom surface of the fitting recessed portion 14.

The upper cutout portion 15b is provided on the one end side in the fitting direction as described above to distribute the cutout portions 15 on the one end side and the other end side in the fitting direction so that a decrease in the strength of the housing 12 can be suppressed as compared to a case where more lower cutout portions 15a are provided only on the other end side in the fitting direction.

Moreover, according to the connector 1 of the present embodiment, the cutout portion 15 is formed to expand in diameter as extending outward of the housing 12 (connector 1). With this configuration, the die for forming the cutout portion 15 can be easily removed from the housing 12, and the accuracy of the cutout portion 15 can be improved.

Further, according to the connector 1 of the present embodiment, the terminal 11 is formed in the shape long in the fitting direction, the housing 12 is formed to have the height corresponding to the length of the terminal 11 in the fitting direction, and the cutout portion 15 is formed to a depth of 50 to 80% of the height of the housing 12 in the fitting direction. Thus, the cutout portion 15 is provided in the vicinity of the center of the terminal 11 in the longitudinal direction thereof so that deformation of the vicinity of the center of the terminal 11 into the housing 12 due to the contraction of the resin of the housing 12 can be suppressed.

Note that in the present embodiment, the example where two lower cutout portions 15a are provided in the lower portion (on the other end side in the fitting direction) of the housing 12 and one upper cutout portion 15b is formed in the upper portion (one end side in the fitting direction) of the housing 12 has been described, but the present disclosure is not limited thereto and the number of cutout portions 15 according to the number of terminals 11 and the width of the housing 12 may be provided in the lower and upper portions of the housing 12.

Moreover, in the present embodiment, the example where the partner connector 2 has two rows of the partner terminals 21 and the connector 1 has two rows of the terminals 11 has been described, but the present disclosure is not limited thereto. The partner connector 2 may have one row or three or more rows of the partner terminals 21, and the connector 1 may have one row or three or more rows of the terminals 11.

The present disclosure may be changed as necessary without departing from the gist or idea of the disclosure which can be interpreted from the entirety of the claims and the specification, and the technical idea of the present disclosure also includes these changes in the connector.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A connector comprising:
a terminal; and
a housing,
wherein the connector includes a terminal row in which a plurality of the terminals is arranged in a longitudinal direction of the connector, and a plurality of the terminal rows is provided so as to face each other in a lateral direction of the connector,
the housing has a fitting recessed portion in which a partner connector is to be fitted and a cutout portion,
the fitting recessed portion is recessed between the terminal rows on one end side of the housing in a fitting direction perpendicular to the longitudinal direction and the lateral direction, and
the cutout portion is recessed between the terminal rows at least on the other end side of the housing in the fitting direction.

2. The connector according to claim 1, wherein
the housing includes the number of the cutout portions according to the number of the plurality of the terminals arranged in the longitudinal direction, and
the cutout portion is provided over an area where a predetermined number of the plurality of the terminals is arranged in the longitudinal direction.

3. The connector according to claim 1, wherein
the housing has, on the one end side in the fitting direction, the cutout portion recessed toward the other end side in the fitting direction from a bottom surface of the fitting recessed portion.

4. The connector according to claim 1, wherein
the cutout portion is formed to expand in diameter as extending outward of the housing.

5. The connector according to claim 1, wherein
the terminal is formed in a shape long in the fitting direction,
the housing is formed to have a height corresponding to a length of the terminal in the fitting direction, and
the cutout portion is formed to a depth of 50 to 80% of the height of the housing in the fitting direction.
